(19) United States
(12) Patent Application Publication
(10) Pub. No.: US 2012/0146497 A1
(43) Pub. Date: Jun. 14, 2012

(54) HIGH-PRESSURE DISCHARGE LAMP

(75) Inventor: Klaus Stockwald, Germering (DE)

(73) Assignee: OSRAM AG, Muenchen (DE)

(21) Appl. No.: 13/377,166

(22) PCT Filed: May 27, 2010
(86) PCT No.: PCT/EP2010/057294

§ 371 Date: Feb. 27, 2012

(30) Foreign Application Priority Data
Jun. 22, 2009 (DE) 10 2009 029 867.3

(51) Int. Cl. H01J 61/32; H01J 61/073

(52) U.S. Cl. 313/631; 313/634

(57) ABSTRACT

In various embodiments, a high pressure discharge lamp may comprise a ceramic elongate discharge vessel with an axis and with a central middle part and two tapering ends, wherein the ends are closed by seals containing electrode systems, and wherein a filling comprising metal halides is situated in the discharge vessel, in which the lamp further comprises a fin-like structure including at least three fins located on at least one tapering end, the structure comprising an attachment having a leading root directly on the discharge vessel and having a trailing root from which an undercut extends in the direction of the seal, wherein the axial length of the attachment is chosen and wherein the axial length of the undercut is at least 30% of the length of the attachment.

### TECHNICAL FIELD

The invention starts from a high pressure discharge lamp according to the preamble of claim 1. Such lamps are in particular high pressure discharge lamps with a ceramic discharge vessel for general lighting.

### PRIOR ART

U.S. Pat. No. 4,970,431 discloses a sodium high pressure lamp in which the bulb of the discharge vessel is made from ceramic. Fin-like projections are attached to the cylindrical ends of the discharge vessel and are used for heat dissipation.

Ceramic discharge vessels are known from WO2007/082885 which include fin-like attachments at the end of the ceramic discharge vessel. These do not have a specific shape, however.

### DESCRIPTION OF THE INVENTION

The object of the present invention is to provide a high pressure discharge lamp whose discharge vessel is effectively cooled.

This object is achieved by the characterizing features of claim 1.

Particularly advantageous embodiments can be found in the dependent claims.

The high pressure lamp is fitted with a ceramic, elongate discharge vessel. The discharge vessel defines a lamp axis and has a middle part and two end regions which are each closed by seals, wherein electrodes are anchored in the seals which extend into the discharge volume enclosed by the discharge vessel, wherein a filling, which preferably contains metal halides, is also situated in the discharge volume. A fin-like structure is located on at least one end region and extends axially parallel outwards and is substantially spaced apart from the seal itself. The seals are tubular capillaries or plug-shaped seals. The use of ceramic gradient cermets, longitudinal or even axial as is known per se, is also possible for this purpose.

In the case of ceramic high pressure lamps with increased burner load in the electrode backspace (for example due to changed convection currents along the colder inner regions of the burner), the outer surface can be dimensioned for radiation cooling by adjusting a cold spot temperature. For flexible adjustment of the surface radiating in NIR, axially parallel extending fin structures (for example fin-like, integral attachments on the burner vessel) have proven to be expedient because they can be achieved relatively easily in terms of production engineering and can be dimensioned in a wide range in terms of the surface area.

The structures must be extended to the sealing region according to the extent of the length/diameter of the burner end. The longitudinal fin structure acts as a thermal bridge to the burner end in this case.

The advantage of the fins is their targeted adjustability. The wall thicknesses of the fin structures can be adjusted in a targeted manner, in particular reduced, and the number of fins may be increased to attain an adequate cooling effect with a simultaneously limited heat flow in all cases.

It has been found that the number of fins leads to a meaningful radiation characteristic, which has a cooling effect, only up to a number of three to a maximum of eight and that the wall thickness of the fins cannot be arbitrarily thin. The locally active cooling effect is distributed over a relatively large end region in this case. A wall thickness of approx. 25-50% of the mean wall thickness that occurs on the burner, in particular the middle part, should preferably not be fallen below here in order to be able to manufacture relatively large quantities in terms of production engineering with minimal rejects.

The cooling effect is decisively improved in that the fins are constructed with an undercut in such a way that the end of the fin structure facing the burner end does not have any contact with the sealing wall, i.e. the capillaries or the plug. This prevents a heat flow from passing onto the seal or even the burner end by way of the axial length LH of the undercut. A loss-determining thermal transfer via the fins is therefore avoided in this region. Particularly effective cooling in the region of the attachment point of the extensive cooling surfaces of these fins consequently results. The axial length of the attachment point is designated LA.

### Advantages

1. Flexible design of the attachment zone of the integral cooling elements (fin structures).

2. Wall thickness of the cooling structure does not have to be significantly reduced since the cooling element does not automatically act as a thermal bridge, but only in the region of the attachment points.

3. A shorter burner zone may be cooled more effectively by way of the fin attachment and a lower efficiency-reducing heat flow can be adjusted in the seal ends thereby.

4. Auxiliary ignition contacting (for example auxiliary ignition contact), which has a slight spacing from the internal power supply line, can preferably take place at the end sealing surface in the region of the undercut. The spacing is substantially defined by the wall thickness of the seal. It is preferably in a range from 0.6 to 1.1 mm.

In the case of ceramic high pressure lamps with increased burner load in the electrode backspace (for example due to changed convection currents along the colder inner regions of the burner), the outer surface can be dimensioned for radiation cooling by adjusting a cold spot temperature. For flexible adjustment of the surface radiating in NIR, axially parallel extending fin structures (for example fin-like, integral attachments on the burner vessel) which can be achieved relatively easily in terms of production engineering have proven to be expedient.

The structures must be extended to the sealing region according to the extent of the length/diameter of the burner end. The longitudinal fin structure acts as a thermal bridge to the burner end in this case. The burner end is preferably designed in such a way that it tapers toward the seal, so fins may be well attached here.

The application of the invention is based in particular on highly efficient ceramic lamps with very high luminous efficacy and high radiation conversion efficiency.

High wall loads of the burner surface of 35-45 W/cm² on the inner surface are attained in particular. Furthermore, the gas convection is changed due to stable adjustment and use of longitudinal, or associated acoustic resonances derived therefrom as is known per se and in such a way that there is intensified suppression of plasma separation as a result of diffusion processes. Gas flows from the center of the high-pressure plasma which forms are guided onto the inner end faces in the electrode backspace.

This leads to increased heating of the end faces that act as cold spots.

It has been found that a certain temperature range of the end faces is required, and should not be exceeded, for adjusting the resulting metal halide steam pressure, in particular for certain, especially Na/Ce-based metal halide fillings, to achieve particularly high luminous efficacy, i.e. high radiation conversion efficiency (efficiency of the generation of visible radiation in the visual spectral range in relation to stored electrical power) and visual efficiency (adjustment of the spectral radiation distribution to the sensitivity of the eye, i.e. lumen yield in relation to radiated power produced in the visual spectral range).

This temperature is substantially in a range between 980 and 1,080° C., in particular typically less than 1,050° C., in the case of the above-mentioned mean wall loads.

Luminous efficacies up to 160 lm/W with very good color reproduction of >80 can be attained in this connection.

With an appropriate design of the burner vessel and the filling composition discharge efficiencies of ≧50% (conversion of electrical power into visual radiation) and visual efficiencies of ≧320 lm/Wᵥᵢₛ may be achieved for the lamp spectrum.

The burner vessels used are burners with a high dimensional ratio of internal length and internal diameter (expressed by an aspect ratio of in particular 3 to 8), and this then also leads to an increased plasma arc length between the electrode tips and corresponding ignition difficulties.

The surface that may be used for end cooling by way of NIR radiation is substantially located in the region of the burner, which surrounds the electrode backspace, and in the adjoining part of the end seal construction.

Any desired surface enlargement may be made by increasing the mass of the sealing zone, although this simultaneously entails an enlargement of the cross-sectional area for the heat flow leading into the end seals.

Enlarged projections to increase the surface with peripheral heat accumulation grooves (annular cooling) are suitable for increased NIR radiation with a simultaneous reduction in the quantity of heat flowing off to the ends but they produce an increased end shadowing of the light intensity radiated into the end zones and therefore lead to a reduction in efficiency.

Axially parallel extending fin structures have proven to be the optimum and easiest to produce surface structure for local NIR surface cooling.

The increased arc length in the discharge vessel with a high aspect ratio leads to an increased need for ignition field strength to initiate lamp operation. In the case of lamps with a ceramic lamp vessel (typically manufactured from Al₂O₃) the seals are end constructions which are designed as thin tubular sealing zones. To decrease the ignition field strength and initiate ignition, ignition may be initiated in the end structures by capacitively coupled auxiliary discharges. Contacting in the immediate vicinity of at least one electrode power supply line toward the electrode tip is best for this purpose.

When using auxiliary ignition contacts (wires and/or conductive coatings) optimally good contacting in the region of the electrode shaft is best.

Attachment of an ignition wire loop or a coating in the leading region, preferably the first third of the lengths LH, of the undercut of the fin structure, is particularly advantageous therefore since the smallest internal gap width in the gas chamber occurs at this point inside the capillaries.

Alternatively (possibly in addition to the methods mentioned above) conductor tracks (made for example of cermet, platinum or conductive carbon layers which reach into the region of the undercut) running between the fins and bridging the burner length may be used as ignition aids.

The fin undercut is particularly effective if the undercut length LH is at least the size of the minimum fin wall thickness WS, preferably a multiple thereof, in particular 3 to 10 times the wall thickness WS.

A particularly advantageous embodiment of the invention lies in the consideration of the following aspects:
the seal is a capillary (cylindrical) with feedthrough, the electrode shaft being partially sunk in the capillary and a certain minimum spacing being preserved between shaft and capillary; it should be at least 10 μm and should optimally not exceed 50 μm;
at least three fins are provided at the end of the discharge vessel which include an undercut (preferably parallel to the capillary);
the root of the attachment of the undercut (trailing root) is located in the region of the electrode shaft in the region of the seal. The minimum spacing of the opening of the capillaries from the discharge volume is 1 mm in the direction of the feedthrough; this trailing root is preferably in the last third of the shaft but still spaced apart from the end of the shaft; the trailing part of the shaft may be reinforced with a coil, etc.

In a specific, particularly preferred embodiment the undercut is used for an ignition aid. In this case an ignition aid (implemented as a wire or strip) in the region between trailing root and end of the shaft acts in such a way that an increased electric field strength sufficient for ignition is produced.

The connection between fin and discharge vessel may itself be located to a small extent on the capillary but only in the sense that the thermal bridge is not substantially shifted onto the capillary as a result. If the total attachment length LA of the fin is considered in the axial length, the part located on the capillary should preferably at most account for up to 40%, preferably not more than 25%, of the axial length LA. Best results are achieved if this part does not account for more than 15%.

The invention relates in particular to lamps with an increased aspect ratio up to 8 or lamps which comprise shortened structures for the seals. The end region preferably includes a tapering internal contour in the electrode backspace. This means that the central part has a maximum or constant internal diameter ID and the end regions have a smaller internal diameter to which they taper.

The fin-like structure is preferably formed around the electrode construction or at the end region. The discharge vessel typically consists of a ceramic containing aluminum, such as PCA or also YAG, AlN or AlYO3. A freestanding cooling structure, substantially spaced apart from the seal, is used which is in particular itself formed from ceramic and is an integral component of the end region in particular.

The invention is particularly suitable for highly loaded metal halide lamps in which the ratio between the internal length IL and the maximum internal diameter ID of the discharge vessel, what is known as the aspect ratio IL/ID, is between 1.5 and 8.

It has been found that with these burner forms a local end cooling is effective if they have end regions tapering toward the end. This improves filling distribution in the burner because the filling is preferably deposited in the region behind the electrodes in what is known as the electrode backspace and therefore leads to improved color stability as well as an increased luminous efficacy. Extremely high luminous efficacy with high color reproduction may be achieved in particular when using fillings containing Na and/or Ce. It has been found that when a suitable operating method is used, for example DE-A 102004004829, the output characteristic of the lamp may be positively influenced, so a luminous efficacy of up to more than 150 lm/W, while retaining a color reproduction index Ra>80, may be achieved which is stable in the long term.

Irrespective of the wall thickness distribution between the electrodes, the temperature gradient with highly loaded burners, which typically achieve a wall load of at least 30 W/cm² in the region of the axial length between the electrodes, may be affected and adjusted by the choice of attachment point for the cooling structure. The constancy of the color temperature and the efficacy of the resulting metal halide lamp can be significantly improved thereby.

By avoiding contact between cooling structure and seal (here an electrode feedthrough capillary), effective cooling is ensured at the attachment point of the cooling structure and at the same time a heat flow onto the seal is avoided. This reduces the losses at the ends and increases the temperature gradient in the region of the seal.

This applies in particular in the case of metal halide lamps which contain at least one of the halides of Ce, Pr or Nd, in particular together with halides of Na and/or Li. Otherwise color temperature variations occur here due to distillation effects.

Use in lamps with a high aspect ratio of 2 to 6 and in lamps with targeted excitation of acoustic resonances which are used to cancel longitudinal segregation in the vertical burning position is also preferred.

PCA or any other conventional ceramic may be used as the material for the bulb. The choice of filling is in principle not subject to any particular restriction either.

Discharge vessels for high-pressure lamps with approximately uniform wall thickness distribution and narrowing end forms have previously exhibited partially high color dispersion as a function of the filling composition due to the strong distribution of the metal halide filling inside the discharge vessel. The filling typically condenses in the region behind a line which is determined by projection of the electrode tip onto the inner burner surface. Previously it has not been possible to position the filling at a zone of the surface inside the discharge vessel, which corresponds to a narrow temperature range, and into the residual volumes of the capillaries so it can be adjusted with sufficient precision.

Previous discharge vessels have often had a form with reinforced wall thickness at the end faces, for example in the case of cylindrical burner forms, and consequently produce an enlarged end surface. A further problem is the increased radiation of IR radiation due to the wall thickness-dependent, specific emission coefficients of the ceramic during operation of the discharge vessel in the evacuated or gas-filled outer bulb.

This results in the inner wall being occupied by filling concentrate due to a heat sink effect at the end of the discharge vessel and in the discharge vessel this occupancy determines the vapor pressure of the metal halides used such that with ceramic lamp systems a satisfactory value of dispersion of the color temperature of at most 75 K may be adjusted for larger lamp groups with the same operating performance.

Particularly serious problems result in the case of spherical discharge vessels or those with semi-spherical end forms or conically tapering end forms or elliptically formed end forms and a cylindrical middle part with a relatively high aspect ratio of IL/ID of about 1.5 to 8. Owing to the tapering transition into the capillary region sometimes inadequate cooling effects result at the end of the discharge vessel and therewith inadequate fixing of the temperature which is not sufficient for accurate filling deposition in a narrow temperature range of the inner wall.

With a burner geometry which does not have a cooling structure, see FIG. 8 of WO 2007/082885, a very small temperature gradient of burner body to sealing structure is produced, and this leads to preferred distillation of the filling in the feedthrough structure.

A further known solution (FIG. 10) are simple fins or fin-like formations. While these increase the cooling surface they form a thermal bridge between burner end and seal, in particular if short cooling lengths are preferred and the cooling structure has an increased number of cooling ribs. These drawbacks are avoided by the inventive cooling structure.

In a preferred embodiment of the invention the cooling structure is completely or partially provided with a coating. It is made from a material which in near infrared (NIR), in particular in the wavelength range between 1 and 3 μm, has an increased hemispherical emissivity ε in a temperature range between 650 and 1,000° C. compared with the ceramic material of the cooling structure. The coating should preferably be applied in the region of the transition between the end of the discharge vessel and the seal.

High temperature-resistant coatings with hemispherical emission coefficients ε preferably ε≧0.6 are suitable as coating materials. These include graphite, mixtures of Al₂O₃ with graphite, mixtures of Al₂O₃ with carbides of the metals Ti, Ta, Hf, Zr and of metalloids such as Si. Mixtures which also contain other metals for adjusting possibly desired electrical conductivity are also suitable.

Obviously both measures may be suitably combined with each other, so some of the increase in surface radiation takes place by way of an enlargement in the surface due to the fin-like structure and at the same time some takes place due to the coating of portions of this fin-like structure or the adjoining colder sealing regions.

Overall a series of advantages result with use of a fin-like structure in the case of ceramic discharge vessels:
1. Effective cooling which can be very precisely localized;
2. Reduction in the longitudinal heat flow into the seal;
3. Significantly increased flexibility of the surface adjustment in the end region;
4. Reduction in the shadowing effect in the field of the solid angle of the electrode feed;
5. Adjustability of effective local thermostat effect by means of relatively small surface regions.

These properties are particularly important for highly loaded forms of discharge vessel with a small overall surface and potentially increased aspect ratio since under these conditions local cooling is difficult due to heat flow over relatively large wall cross-section surfaces.

The total mass of the discharge vessel increases only insignificantly due to this type of fin-like structure and therefore remains under a critical value which would adversely affect the start-up behavior of the lamp on ignition. There is therefore an elaborate compromise between good ignition and effective cooling. This measure allows very high color stability with the conscious acceptance of poor isothermics. This occurs in a departure from the previous objective of optimally good isothermics and allows the condensation zone of the filling to be exactly determined by deliberate formation of a temperature gradient.

The cooling effect may be controlled in particular by the maximum radial height of the fin-like structure since the dissipation takes place from a different temperature level depending on the attachment height.

A particular advantage of such a fin-like structure is that in addition to effective cooling, it may also be easily produced if modern manufacturing methods such as injection molding, slip casting or rapid prototyping are used.

### BRIEF DESCRIPTION OF THE DRAWINGS

The invention shall be described in more detail below with the aid of several exemplary embodiments. In the figures:

FIG. 1 shows a high pressure discharge lamp with discharge vessel,

FIG. 2 shows a detail of the discharge vessel from FIG. 1 in perspective (FIG. 2a) and in longitudinal section (FIG. 2b),

FIG. 3 shows a section through the end region of FIG. 2,

FIG. 4 shows a further exemplary embodiment of an end region of a discharge vessel with ignition strip,

FIG. 5 shows a further exemplary embodiment of an end region of a discharge vessel with ignition wire,

FIG. 6 shows a section through the end region of FIG. 5.

### PREFERRED EMBODIMENT OF THE INVENTION

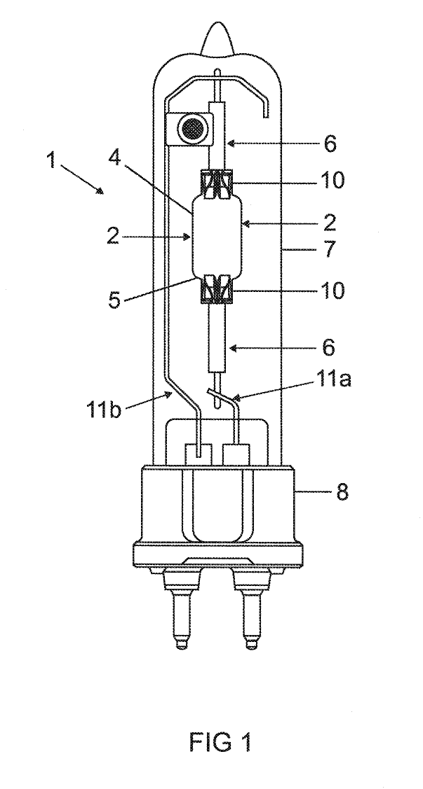

FIG. 1 shows a metal halide lamp 1. It includes a tubular discharge vessel 2 made of ceramic into which two electrodes are introduced (not visible). The discharge vessel has a middle part 5 and two ends 4. Two seals 6, which are constructed as capillaries, are located at the ends. The discharge vessel and the seals are preferably integrally produced from a material such as PCA.

The discharge vessel 2 is surrounded by an outer bulb 7 which terminates a base 8. The discharge vessel 2 is held in the outer bulb by means of a frame which contains short and long power supply lines 11a and 11b. A respective fin-like structure 10 which encircles the seal 6 is located at the burner end.

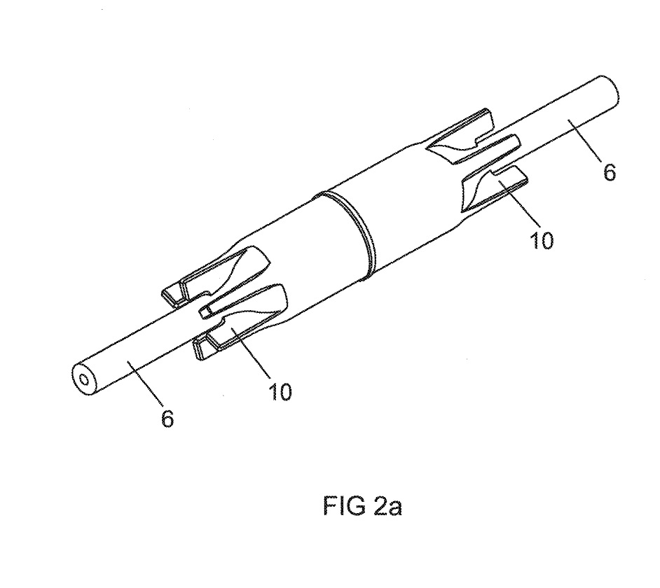

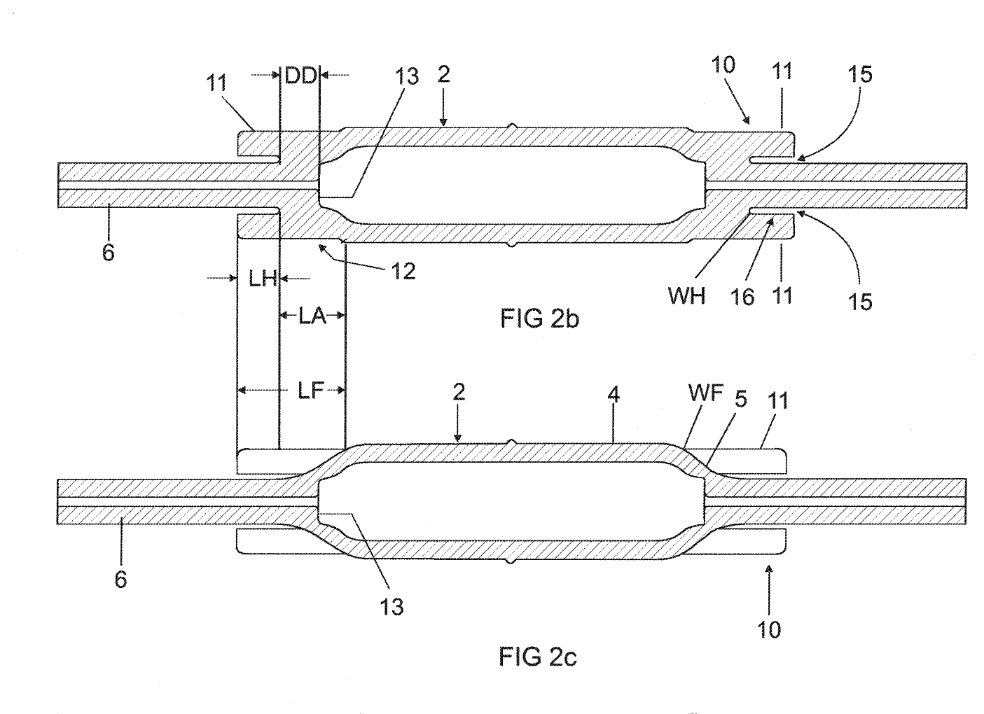

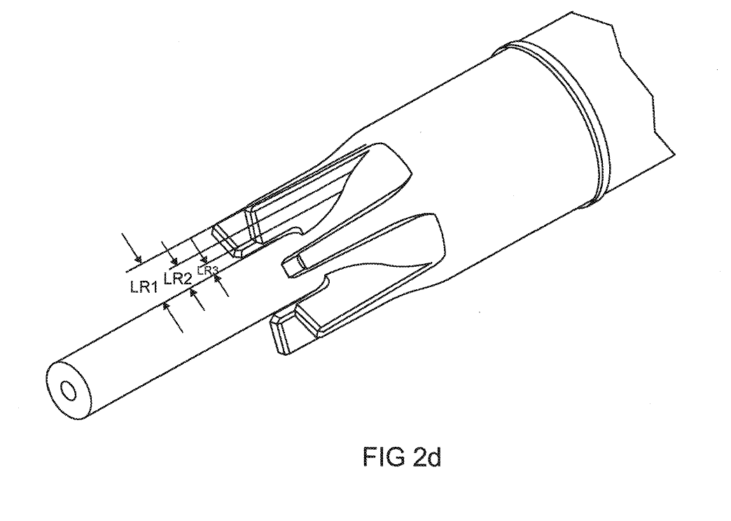

FIG. 2a shows a fin-like structure 10 in perspective view in connection with a capillary 6. Instead of a capillary a short plug may also be used.

FIGS. 2b and 2c show a longitudinal section of a discharge vessel, each rotated by 90°. The fin-like structure 10 including four fins 11 externally attaches in an integrally fitted manner the tapering end region 5 of the discharge vessel 2 and extends in its overall axial extension LF a long way in the direction of the capillary 6. The fin 11 has an attachment or bridge area 12 with axial length LA which connects to the end of the discharge vessel. This attachment extends substantially over the tapering end 5. The leading root WF of the fin close to the discharge does not necessarily have to attach to the outer wall of the middle part of the discharge vessel but may also attach lower down, and not until downstream of the middle part, in the region of the tapering end 5. The trailing root WH remote from the discharge is located here at the end of the tapering region where for example the capillary begins. This trailing root WH can be located at the beginning of the capillary, in particular on the leading tenth of the length of the capillary. It is important that axially the trailing root WH has at least 1 mm spacing from the end of the internal volume, here represented by the end face 13. This spacing is designated DD in FIG. 2b.

The leading root WF of the fin-like structure 10 attaches in particular to the tapering end region and, viewed axially, extends further outwards with the bridge area ending approximately at the height of the capillary. The bridge area can still extend slightly over the capillary. The fin 11 is provided with an undercut 15. The root WH of the undercut is located where the bridge area ends. The edge 16 of the undercut extends for the most part parallel to the capillary 6, so its spacing from the capillary is constant, and this facilitates manufacture. However, it is also possible for the spacing to increase slightly to the outside. An angle of 1 to 10° towards the axis is preferred here, and this facilitates removal without the desired cooling effect, which is based on an optimally large total area per mm fin length, suffering as a result.

The axial length LH of the undercut is optimally selected such that it corresponds to at least 20% of the axial length LA of the attachment or bridge area, preferably considerably more and preferably in a range from 35 to 150% of this length, in particular 50 to 110%. An optimally large radiating surface, namely the two side surfaces of a plate-like fin 11, is achieved in this way which is decoupled from the attachment length LA of the fin and, furthermore, the site of action of this attachment. The longer LA is, the more effective cooling is compared with cooling which a conventional fin achieves without an undercut.

FIG. 2d shows a detail which illustrates the possibility of a differently chosen radial length LR of the fin. Here a fin 10 is singled out in which three different conceivable heights LR1, LR2 and LR3 are shown in broken lines. The larger LR is chosen to be, the shorter the overall axial length of the fins can be to achieve substantially the same radiating surface.

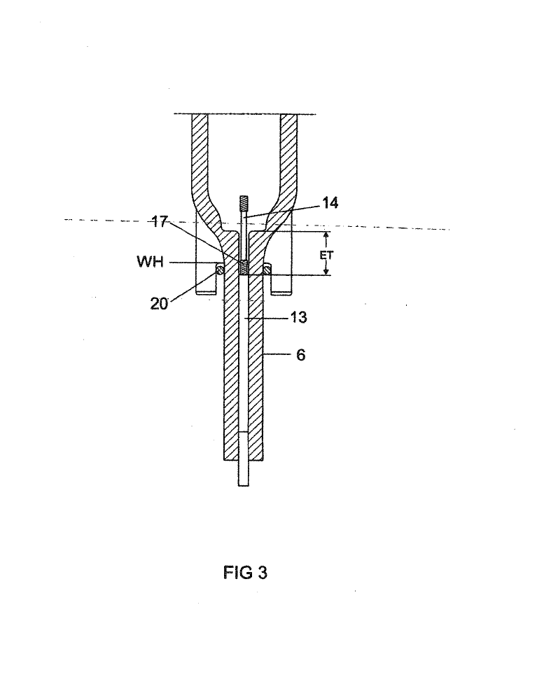

Particularly effective cooling is based according to FIG. 3 on the fact that the feedthrough 13 is completely sunk into the capillary 6 at the discharge side, with the electrode shaft 14 extending to a depth ET into the capillary. A minimum spacing of 20 μm between the capillary and the electrode shaft is preserved so the filling can extend into this gap. The trailing root WH, which is simultaneously the root of the attachment of the undercut, should still be located in the region of the electrode shaft 14. It is preferably located in the last third of the length of the shaft facing away from the discharge. However, it should preferably not be located in the region of the feedthrough 13. This root should, however, be slightly spaced apart from the trailing end of the shaft. A spacing of 5 to 35% of the length of ET is usually a good choice. The shaft still has a coil 17 in the trailing region which minimizes the gap. The electrode shaft has a thickened part 17 precisely at the level of the ignition aid, so the gap to the capillary wall has an optimum width. Ignition aid and cooling structure cooperate optimally in this way.

In general the root WH can also be located in the tapering end region of the discharge vessel. Its positioning relative to the trailing end of the electrode shaft is important.

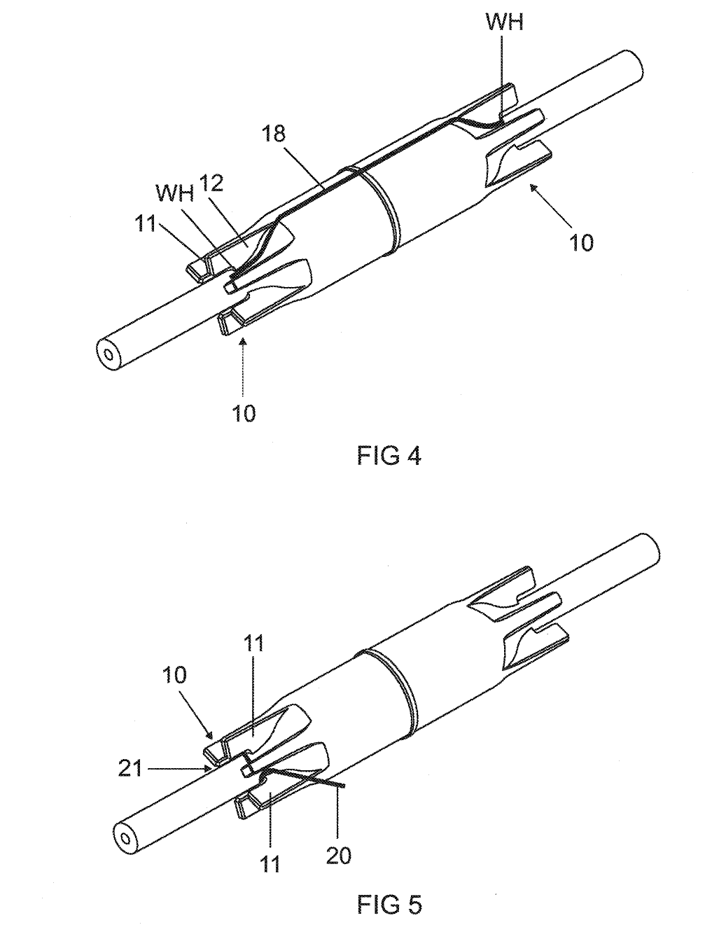

FIG. 4 shows a fin-like structure 10 which is advantageously combined with an ignition aid 18 on the outside of the discharge vessel. The ignition aid 18 is a ceramic ignition strip on the outside of the discharge vessel which runs parallel to the axis of the discharge vessel. It is, for example, a sintered-on ignition strip made of W-A1203 cermet. Basically ignition strips of this kind are known, see DE-A 199 01 987 and DE-A 199 11 727 in this regard. The ignition strip 18 extends from a fin-like structure 10 at a first end of the discharge vessel to a fin-like structure 10 at the second end. The ignition strip 18 begins and ends precisely in the vicinity of the root WH of a fin and runs at the foot of the fin 11 along the bridge area 12, so the ignition strip is protected in this area to an extent by the fin 11 from damage during assembly.

Finally it is also possible to combine the fin-like structure 10 with an auxiliary ignition wire 20, see FIG. 5 and FIG. 3. In this case the ignition wire 20 is shaped to virtually form a loop which is fitted into the undercut 21 of the fin 11 in the vicinity of the trailing root, whereby it is simultaneously fixed. Cooling mechanism and ignition mechanism thus optimally cooperate. The gap width of the undercut can advantageously be selected such that the auxiliary ignition wire is adapted to the gap width or optionally also the wire thickness of the gap width. This ensures the correct seat of the wire at the most effective position for ignition and separate fixing is not required either. The wire can even be provided with appropriate notches to optimally arrest it in the rim of the fins 11 of a structure 10.

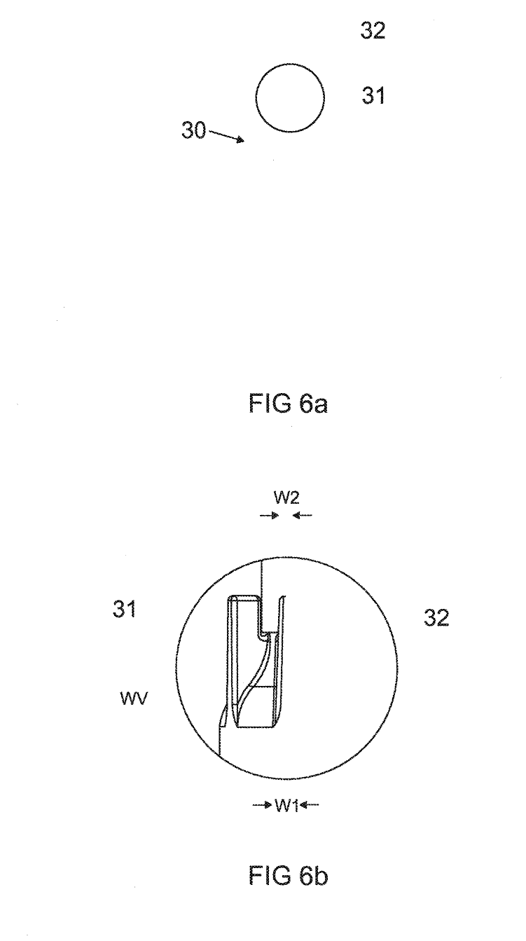

FIG. 6 shows a plan view FIG. 6a and a detailed view FIG. 6b of a discharge vessel 30 in which the seal is implemented by a capillary. Four fins 31 are uniformly distributed over the circumference. Each fin 31 has an initial wall thickness W1 in the region of the leading root WV. The wall thickness of the fin 31 tapers backwards to a wall thickness W2 which is only about 40 to 80% of the wall thickness W1. The top edge 32 of the fin is slightly beveled.

If instead of the fin-like structure an annular structure was used the cooling effect on the surface zone of the burner vessel would be more uniform but, viewed relatively, the radiating surface would be considerably smaller and combination with an ignition aid would not be practical. An ignition aid would be more of a hindrance with an annular structure.

The radial height LR of the plate-like fin 11 is preferably at least 50% of the difference between capillary and maximum external radius of the central region of the discharge vessel.

The spacing between the fins should preferably be at least three to five times the mean wall thickness. The mean wall thickness WM of a fin should in particular be a maximum of 1/10 of the circumference, based on the maximum external radius of the discharge vessel. This should ensure that the radiation of one fin does not heat the nearest fin.

A mean wall thickness is nevertheless defined in the case of an axially variable wall thickness. By way of example WM=(W1+W2)/2 in the case of FIG. 6.

The fins are usually plate-like as this is the simplest way of producing them. However, more complicated fin structures are not ruled out. The fins are substantially plate-like with an axial length LF=LA+LH and with a maximum height LR. They may in particular also be stepped in a terraced fashion with different heights LR of sections.

Fundamental features of the invention in the form of a numbered list are:
1. A high pressure discharge lamp including a ceramic elongate discharge vessel with an axis and with a central middle part and two tapering ends and an axis, wherein the ends are closed by seals, which are preferably constructed as capillaries, wherein electrode systems are anchored in the seals, wherein a filling, containing metal halides, is situated in the discharge vessel, characterized in that a fin-like structure consisting of at least three fins is located on at least one tapering end, the structure including an attachment having a leading root directly on the discharge vessel and having a trailing root from which an undercut extends in the direction of the seal, wherein the axial length of the attachment LA is chosen and wherein the axial length LH of the undercut is at least 30% of LA.
2. The high pressure discharge lamp as claimed in claim 1, characterized in that the fins are substantially plate-like with an axial length LF=LA+LH and with a maximum height LR.
3. The high pressure discharge lamp as claimed in claim 1, characterized in that the axial length LH is 80% to 180% of LA.
4. The high pressure discharge lamp as claimed in claim 1, characterized in that the electrode system comprises a shaft and a feedthrough, the shaft extending over a length ET into the capillaries, a gap remaining between shaft and capillary and the trailing root being located in the region of the length ET.
5. The high pressure discharge lamp as claimed in claim 4, characterized in that the trailing root is located in the last third of the length ET.
6. The high pressure discharge lamp as claimed in claim 1, characterized in that an ignition aid is provided on the discharge vessel which locally produces on an electrode system a high electric field strength sufficient for ignition.
7. The high pressure discharge lamp as claimed in claim 6, characterized in that the ignition aid is an ignition strip which extends axially on the outside of the discharge vessel and ends in the immediate vicinity of the trailing root.
8. The high pressure discharge lamp as claimed in claim 1, characterized in that the ignition aid is an auxiliary ignition wire which forms a loop which is fixed in the undercut.

1. A high pressure discharge lamp comprising, a ceramic elongate discharge vessel with an axis and with a central middle part and two tapering ends and an axis, wherein the ends are closed by seals, containing electrode systems wherein a filling comprising metal halides is situated in the discharge vessel, further comprising a fin-like structure including at least three fins located on at least one tapering end, the structure comprising an attachment having a leading root directly on the discharge vessel and having a trailing root from which an undercut extends in the direction of the seal, wherein the axial length of the attachment is chosen and wherein the axial length of the undercut is at least 30% of the length of the attachment.

2. The high pressure discharge lamp as claimed in claim 1, wherein the fins are substantially plate-like with an axial length equal to the sum of the axial length of the attachment and the axial length of the undercut, and having predetermined radial height.

3. The high pressure discharge lamp as claimed in claim 1, wherein the axial length of the undercut is 80% to 180% of the axial length of the attachment.

4. The high pressure discharge lamp as claimed in claim 1, wherein the electrode system comprises a shaft and a feedthrough, the shaft extending over a predetermined length into the capillaries, a gap remaining between shaft and capillary and the trailing root being located in the region of the predetermined length.

5. The high pressure discharge lamp as claimed in claim 4, wherein the trailing root is located in the last third of the predetermined length.

6. The high pressure discharge lamp as claimed in claim 1, wherein an ignition aid is provided on the discharge vessel which locally produces on an electrode system a high electric field strength sufficient for ignition.

7. The high pressure discharge lamp as claimed in claim 6, wherein the ignition aid is an ignition strip which extends axially on the outside of the discharge vessel and ends in the immediate vicinity of the trailing root.

8. The high pressure discharge lamp as claimed in claim 1, wherein the ignition aid is an auxiliary ignition wire which forms a loop which is fixed in the undercut.

9. The high pressure discharge lamp as claimed in claim 1, wherein the seals are constructed as capillaries.

10. The high pressure discharge lamp as claimed in claim 2, wherein the radial height of the plate-like fin is preferably at least 50% of the difference between the axis and maximum external radius of the central region of the discharge vessel.
